(19) United States
(12) Patent Application Publication
(10) Pub. No.: US 2008/0237378 A1
(43) Pub. Date: Oct. 2, 2008

(54) System and Method for Removing Zest from the Citrus and Fruit Rinds

(76) Inventor: Arthur Harris, New York, NY (US)

Correspondence Address: JACKIE JAY SCHWARTZ, 1350 Broadway, Suite 1510, NEW YORK, NY, 10018, US

(21) Appl. No.: 11/867,795

(22) Filed: Oct. 5, 2007

Related U.S. Application Data
(60) Provisional application No. 60/828,422, filed on Oct. 6, 2006.

(51) Int. Cl. A47J 43/25

(52) U.S. Cl. 241/93

(57) ABSTRACT

A system for removing zest from a rind includes a mobile member for receiving the rind thereon. The mobile member is movable in a lateral direction between a start position and an end position. At least one grater is positioned along the path of the mobile member. The grater removes the zest from the rind as the mobile member moves between the start and the end positions. A first receptacle receives the zest removed by the grater and a stop member is positioned at the end position for removing the zested rind from the mobile member.

### CROSS-REFERENCE TO RELATED APPLICATIONS

This application claims the benefit of U.S. Provisional Application No. 60/828,422 filed Oct. 6, 2006.

### FIELD OF THE INVENTION

The present invention relates to fruit zesters and, more specifically, to a system and method for removing the zest from large quantities of citrus and other fruits.

### BACKGROUND OF THE INVENTION

Presently, fruit zest is used in cooking more frequently now than in the past. However, to obtain zest, cooks must remove the zest themselves from the fruit using hand graters and rasps as no pre-packaged zest is available. Additionally, after commercial juice companies extract juice from the fruit, the rind, pith and residue from the fruit are ground up and used for production of other products such as feed and fertilizer.

There are numerous devices currently available for zesting fruit. While these devices may be suitable for the purposes for which they were designed, they would not be suitable for the purposes of the present invention, as hereinafter described.

### SUMMARY OF THE INVENTION

The commercial zesting system according to invention principles includes a conveyor having a plurality of slots. Each slot receives and retains a rind of a fruit therein after the fruit has had the juice extracted therefrom. The conveyor moves the rinds into position at an end of a mobile member or spearhead and in front of a guide. Alternatively, a guide may be positioned within each slot on the conveyor. The spearhead moves in a direction substantially perpendicular to the conveyor and grabs the rind. The rind from which the juice has been extracted may need to be opened slightly prior to placement or when placed on the conveyor as the extraction process may have flattened the rind such that the spearhead is unable to be received within and grab the rind. At least one grater is positioned along the path of movement of the spearhead. The spearhead advances the rind through the guide to shape the rind and past the grater causing the rind to contact the grater and thereby removing the zest from the rind. The zest is collected in a basket positioned below the grater. At the end of the path of movement of the spearhead, at a position past the grater, the rind is removed from the spearhead and dropped into a receptacle and the spearhead returns to it's original position. A subsequent rind is positioned by the conveyor between the guide and the spearhead and the process is repeated.

The zesting system according to invention principles provides juice processors an additional market in which to sell products. In the zesting system according to invention principles the at least one grater can either rotate or remain stationary. Additionally, the at least one grater may be spring loaded to ensure only the zest is grated from the rind, leaving the pith intact.

The system and method according to invention principles efficiently removes the zest from the rinds of large amounts of citrus and other fruits. A fruit rind is retained in a slot in a conveyor. A spearhead grabs the fruit rind from the conveyor as the rind is passed into the path of movement of the spearhead by the conveyor. The rind grabbed by the spearhead is shaped to the contours of the spearhead by passing the rind through a pair of guide plates. The guide plates compress the rind to the shape of the spearhead, preferably an elliptical shape, prior to passing against the grater. The guide plates may either be stationary and positioned between the conveyor and the grater or a pair of guide plates may be positioned within each slot on the conveyor. The edges of the spearhead are smooth so as to prevent piercing of the rind. The spearhead may include a tab on each side thereof. The conveyor may include a track for receiving the tabs to maintain the predetermined level of the spearhead and assure the rind is aligned with the grates to ensure efficient zesting of the rind.

At least one pair of graters are positioned adjacent to the conveyor and are spaced apart to allow the spearhead and rind to pass between them. The graters are shaped to reflect the contour of the spearhead and the rinds shaped by the guides. The graters may be stationary or may rotate about an axis in a direction opposite to the direction of movement of the spearhead. The graters may also be one fixed roller or a series of smaller rollers that are mounted onto a shaped axel matching the contours of the spearhead and shaped rind. In an alternate embodiment, a tube of flexible semi-circular overlapping graters are used. In the tube embodiment, the overlapping graters expand and contract, thereby expanding and contracting the tube without the sharp ends of the graters catching on one another

As the spearhead advances the rind past the graters, the graters contact the rind scraping the zest from the rind. The graters are at least one of spring loaded or controlled by sensors enabling the depth of scraping of the graters to be adjusted so that only the zest is removed from the rind, leaving the pith intact.

After the mobile member has advanced the rind a pre-determined distance between the graters, a slotted comb may shuttle across behind the extended spearhead. As the spearhead returns to the starting position, the slotted comb removes the rind therefrom. Alternatively, the overlapped graters may remove the rind as the spearhead returns to the starting position. The zest is received by a receptacle positioned below the graters. The removed rind is received by a further receptacle positioned below the comb. The removed rind may then be used for other purposes such as feed and fertilizer.

### BRIEF DESCRIPTION OF THE DRAWING FIGURES

In order that the invention may be more fully understood, it will now be described, by way of example, with reference to the accompanying drawing in which:

FIG. 1 is a top view of an embodiment of the system for commercially removing zest from fruit according to invention principles;

FIG. 2 is a top view of an embodiment of the system for commercially removing zest from fruit according to invention principles;

FIG. 3 is a perspective view of an embodiment of the system for commercially removing zest from fruit according to invention principles;

FIG. 4 is a top view of an embodiment of the system for commercially removing zest from fruit according to invention principles;

FIG. 5 is a top view of an embodiment of the system for commercially removing zest from fruit according to invention principles;

FIG. 6 is a flow diagram of the system for commercially removing zest from fruit according to invention principles;

FIG. 7 is a flow diagram of the system for commercially removing zest from fruit according to invention principles; and

FIG. 8 is a perspective view of an embodiment of the system for commercially removing zest from fruit according to invention principles.

### DETAILED DESCRIPTION OF THE INVENTION

The following discussion describes in detail the system and method for removing zest from a rind according to invention principles. This discussion should not be construed, however, as limiting the invention to the particular embodiments described. Practitioners skilled in the art will recognize numerous other embodiments as well.

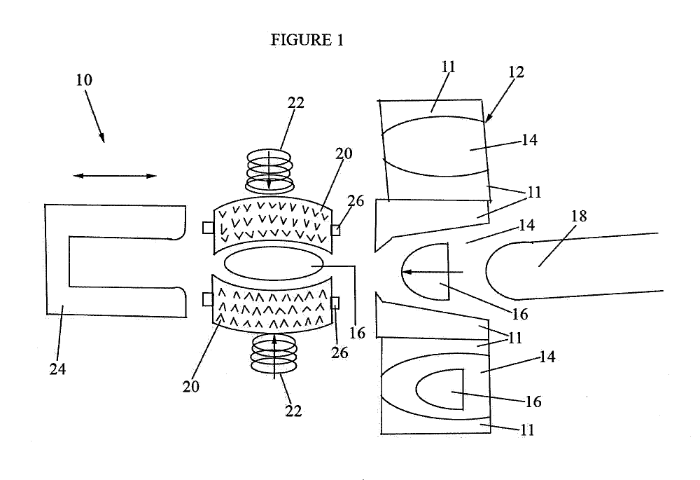

Turning now to the drawings, in which similar reference characters denote similar elements throughout the several views, FIGS. 1 through 8 illustrate a zesting system which is indicated generally by the reference numeral 10.

FIG. 1 is a top view of an embodiment of the zesting system 10 of the present invention. The system includes a conveyor 12 having a plurality of slots 14 therein. A rind 16 is retained in each of the slots 14. If the rind has been flattened it must be opened at least slightly prior to or upon positioning within a slot 14 on the conveyor 12. Positioned within each slot is a pair of guide plates 11 for use in shaping the rind 16 as it is passed therebetween. A spearhead 18, advances from a start position in a direction perpendicular to the direction of extension of the conveyor 12 and towards the conveyor 12. As a slot is aligned with the spearhead 18, the spearhead moves towards and grabs the rind 16. The conveyor 12 may move horizontally perpendicular to the direction of movement of the spearhead 18. Alternatively, the conveyor 12 may rotate about an axis so as to position a slot and a rind therein in alignment with the spearhead as it reaches the apex of rotation. The rind is received on an end of the spearhead and is advanced through the pair of guide plates 11. Alternatively, the guide plates 11 may be positioned on a side of the conveyor 12 opposite the starting point of the spearhead 18. The guide plates 11 shape the rind 16 prior to zesting.

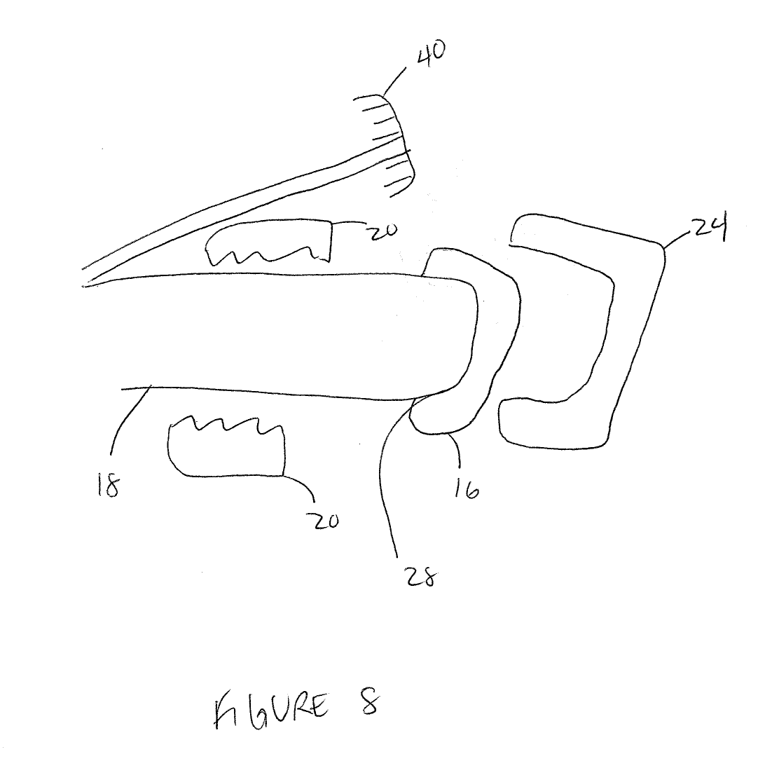

A pair of graters 20 are shaped to reflect the contour of the spearhead 18 and are positioned on a side of the guide plates 11 along the direction of movement of the spearhead 18. The grating side of each of the pair of graters 20 face each other. The spearhead 18 advances the rind 16 between the pair of graters 20 so that the graters 20 remove the zest from the rind 16, leaving the pith of the rind 16 intact. The graters 20 are shown in FIG. 1 as being connected to springs 22 and thereby spring loaded so that the position of the graters are able to be adjusted and thus more efficiently remove only the zest from the rind. In an alternate embodiment, the graters 20 may be stationary and spaced to provide grating of the rind based upon the shape and dimensions of the spearhead 18. The distance separating the pair of graters 20 is adjustable to fit different sized rinds. The springs 22 connected to the graters 20 aid in the adjustment of the spacing of the graters 20. The pair of graters 20 may also use sensors 26, to adjust to accommodate the different sized rinds. The spearhead 18 advances through the graters 20 until reaching a stop member 24. The step member 24 engages the rind 16 and removes from rind from the spearhead 18, as described hereinafter with respect to FIG. 8. The spearhead 18 then returns to the start position for receiving and zesting another rind.

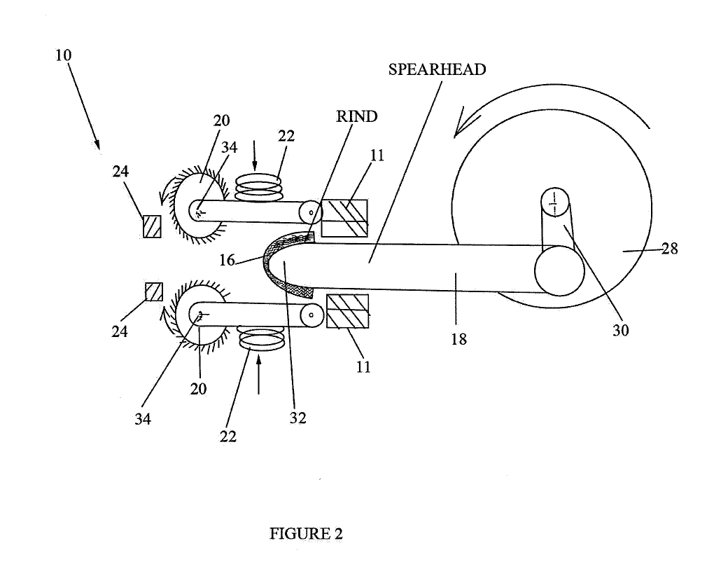

FIG. 2 is a top view of an embodiment of the commercial zesting system 10 of the present invention. Herein, the spearhead 18 is shown attached to a rotating gear 28 by a connection arm 30 that advances and retracts the spearhead 18. As the rotating gear 28 rotates, the spearhead is caused to advance across the conveyor 12, grab a rind 16, through the guide plates 11 and through the space provided between the graters 20. Upon reaching a predetermined point, the rotating gear then causes the spearhead to retract back to its original starting position to grab a subsequent rind to be zested. The spearhead 18 includes a rounded end 32 opposite the connection to the connection arm 30 of the rotating gear 26. The rounded end 28 received the rind 16 from the conveyor 12 and advances the rind 16 through the pair of guide plates 11. The end 28 of the spearhead 18 is rounded or oval in shape to prevent the rind 16 from being pierced. The pair of graters 20 are shaped to reflect the contour of the mobile member 18. The grating side of each of the pair of graters 20 face each other. The graters 20 shown in FIG. 2 are circular and rotate about an axis 34. Additionally, the graters 20 are each connected to a respective spring 22 and are spring loaded for adjusting the position of the graters to efficiently remove only the zest from the rind. The direction of rotation of the graters 20 is opposite to the direction of movement of the spearhead 18. The spearhead 18 further advances the rind 16 between the pair of graters 20 so that the graters 20 remove the zest from the rind 16, leaving the pith of the rind 16 intact. Herein, the graters 20 rotate about an axis in a direction opposite to the direction of movement of the spearhead 18. In an alternate embodiment, the graters 20 may be stationary. The distance separating the pair of graters 20 is adjustable and controlled by the springs 22 to fit different sized rinds. The pair of graters 20 may also use sensors, not shown, for adjusting the position thereof and accommodate the different sized rinds. The spearhead 18 advances until it reaches at least one stop member 24, where the rind 16 is removed from the spearhead 18, as described hereinafter with respect to FIG. 8. The rotating gear 28 then causes the spearhead 18 to return to the start position for retrieving another rind.

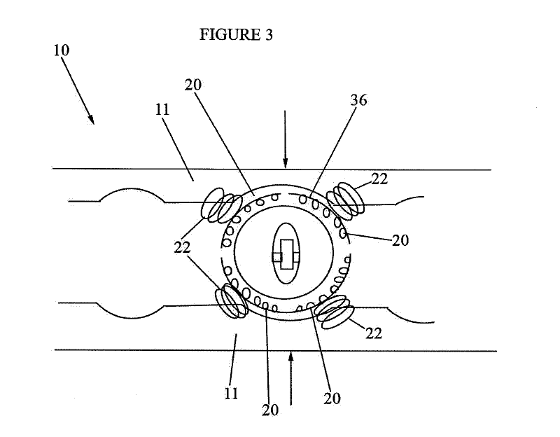

FIG. 3 is a perspective view of an embodiment of the zesting system 10 according to invention principles. The embodiment shown herein provides an alternate arrangement for the graters 20. The illustrated arrangement includes a plurality of semi-circular graters 20. The graters 20 are flexible and thus able to overlap to form a grating tube 36 where the grating surface of the graters 20 face the interior of the tube 30. The grating tube 30 is stationary. After advancing the rind 16 through the guide plates 11, the spearhead 18, not shown, advances the rind 16 through the grating tube 36. The zest is grated from the rind 16 as the rind 16 passes through the grating tube 36. The overlap of the graters 20 and thus the size of the grating tube 36 may be adjustable to accommodate different sized rinds 16. The grating tube 36 may be spring loaded, including springs 22, to aid in the adjustment of the dimensions of the tube 36. The grating tube 36 may also use sensors, not shown, to adjust the dimensions of the tube 36 and thereby accommodate different sized rinds and selectively only grate the zest from each rind 16. The spearhead 18 advances the rind through the grating tube 36 until the spearhead 18 reaches the at least one stop member 24, described above with respect to FIG. 2. The stop member 24, as shown in FIG. 2, grabs the rind and removes the rind 16 from the spearhead 18 as the spearhead 18 retracts back to the start position, as described hereinafter with respect to FIG. 8.

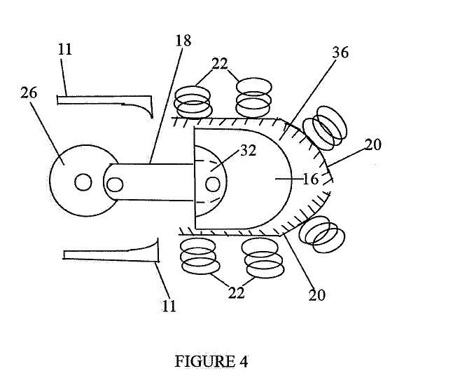

FIG. 4 is a top view of an embodiment of the zesting system 10 according to invention principles. Herein, the spearhead 18 is attached to the gear 26 that advances the spearhead 18 through the guide plates 11 and graters 20. The spearhead 18 includes a rounded end 32 on a side of the spearhead 18 opposite the connection to the gear 26. The rounded end 32 grabs the rind 16 from the conveyor 12 as the rind is moved into alignment with the path of the spearhead 18. The spearhead 18 then advances the rind 16 through the pair of guide plates 11. The end 32 of the spearhead 18 which grabs the rind is rounded to prevent the rind 16 from being pierced. The embodiment shown herein includes the plurality of semi-circular graters 20. The graters 20 are flexible and thus able to overlap to form the grating tube 36 where the grating surface of the graters 20 face the interior of the tube 30. The grating tube 36 is stationary. The spearhead 18 advances the rind 16 through the grating tube 36. The zest on the rind is grated from the rind 16 as the rind 16 passes through the grating tube 36. The overlap of the graters 20 and thus the dimensions of the grating tube 36 may be adjustable to accommodate different sized rinds 16. The grating tube 36 may be spring loaded and include springs 22 connected thereto for adjusting the dimensions of the tube 36 to allow passage of the rind and zesting of the rind as it passes therethrough. The grating tube 36 may also use sensors, not shown, to adjust the dimensions of the tube and thereby accommodate different sized rinds. The spearhead 18 advances through the tube 36 until it reaches the at least one stop member 24, described above with respect to FIG. 2. The stop member 24 grabs the rind from the spearhead 18 and removes the rind 16 from the spearhead 18, as described hereinafter with respect to FIG. 8. The spearhead 18 then returns to the start position.

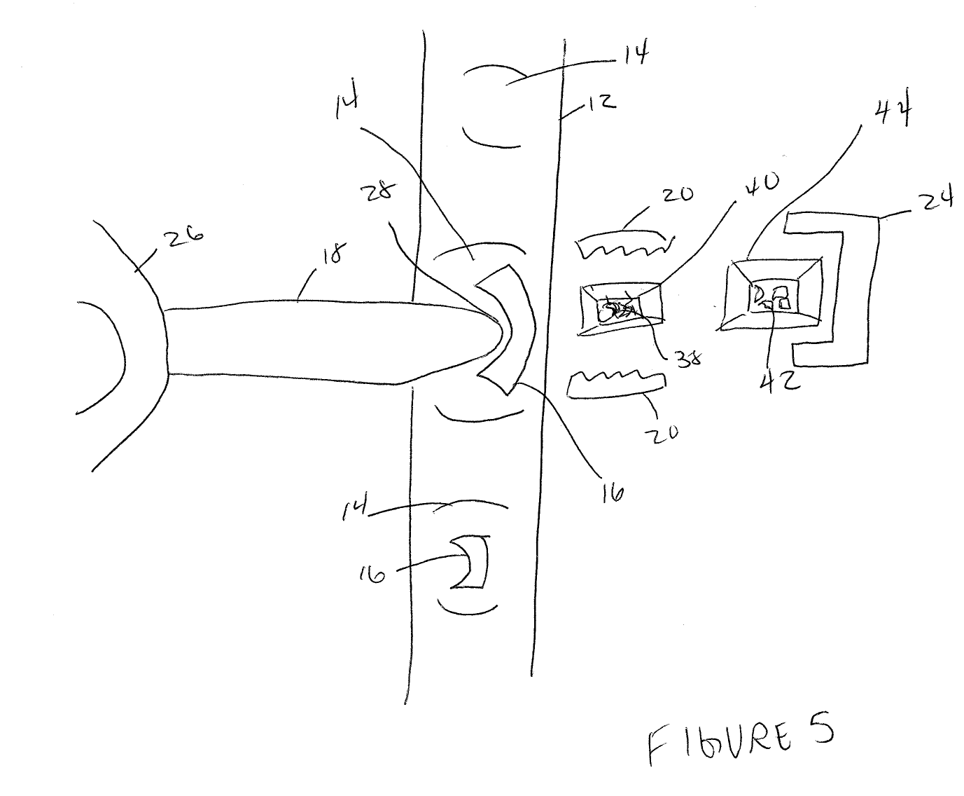

FIG. 5 is a top view of an embodiment of the zesting system 10 according to invention principles. The system includes the conveyor 12 having the plurality of slots 14 therein. The conveyor 12 may move in any of a rotating or horizontal manner in order to align the rind with the system for zesting thereof. The rinds 16 are received by respective slots 14 of the conveyor 12 and are positioned in alignment for zesting by the system. If the rinds received by the slots are flattened, they may be squeezed or otherwise reformed to open the rind and provide a spacing between the sides of the rind for receiving the spearhead 18 therein. The spearhead 18 advances from a start position towards the conveyor 12 and grabs a rind 16 positioned in alignment with the path of movement of the spearhead 18. The rind 16 is advanced by the spearhead 18 through the pair of guide plates 11. The pair of graters 20 are shaped to reflect the contour of the spearhead 18. The grating side of each of the pair of graters 20 face each other. The spearhead 18 advances the rind 16 between the pair of graters 20 so that the graters 20 remove the zest 38 from the rind 16, leaving the pith of the rind 16 intact. The zest 36 falls from the rind 16 into a zest receptacle 40 positioned below the graters 20. The distance separating the pair of graters 20 is adjustable to allow for zesting of different sized rinds. The pair of graters 20 may be spring loaded and include springs 22 connected thereto or sensors to adjust the spacing of the graters 20 for accommodating the different sized rinds. The spearhead 18 advances through the graters and up to a stop member 24. The stop member 24 grabs the zested rind 42 from the spearhead 18 and removes the zested rind 42 from the spearhead 18. The zested rind 28 is deposited in a rind receptacle 44 positioned below the stop member 24. The mobile member 18 returns to the start position.

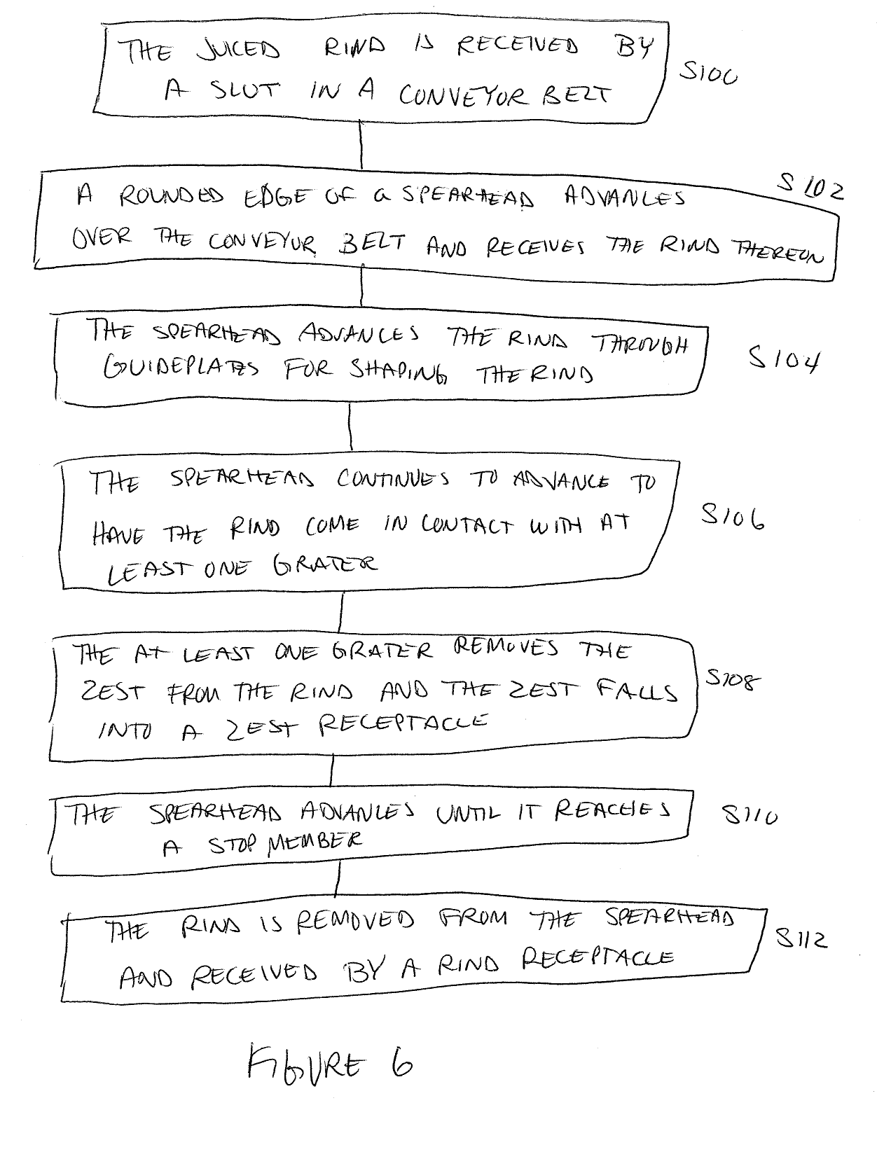

FIG. 6 is a flow diagram describing the method of zesting according to invention principles. In step S100, the juiced rind 16 is received by a slot 14 in a conveyor belt 12. If the juiced rind is completely flattened, the rind may need to be squeezed to provide a small opening for aiding in the receipt of the spearhead therein. In step S102, a rounded edge of the spearhead 18 advances over the conveyor belt 12 and grabs the rind 16. Then in step S104, the spearhead 18 advances the rind through guide plates for shaping the rind to the desired dimensions for removing the zest therefrom. As described in step S106, the spearhead 18 passes the shaped rind across at least one grater 20 thereby removing the zest 36 from the rind 16. The removed zest falls from the rind and into a zest receptacle 32 as discussed in step S108. As stated in step S110 the spearhead 18 advances past the graters and towards a stop member 24. The rind 16 is removed from the spearhead by the stop member 24 and received by a rind receptacle 34 as stated in step S112.

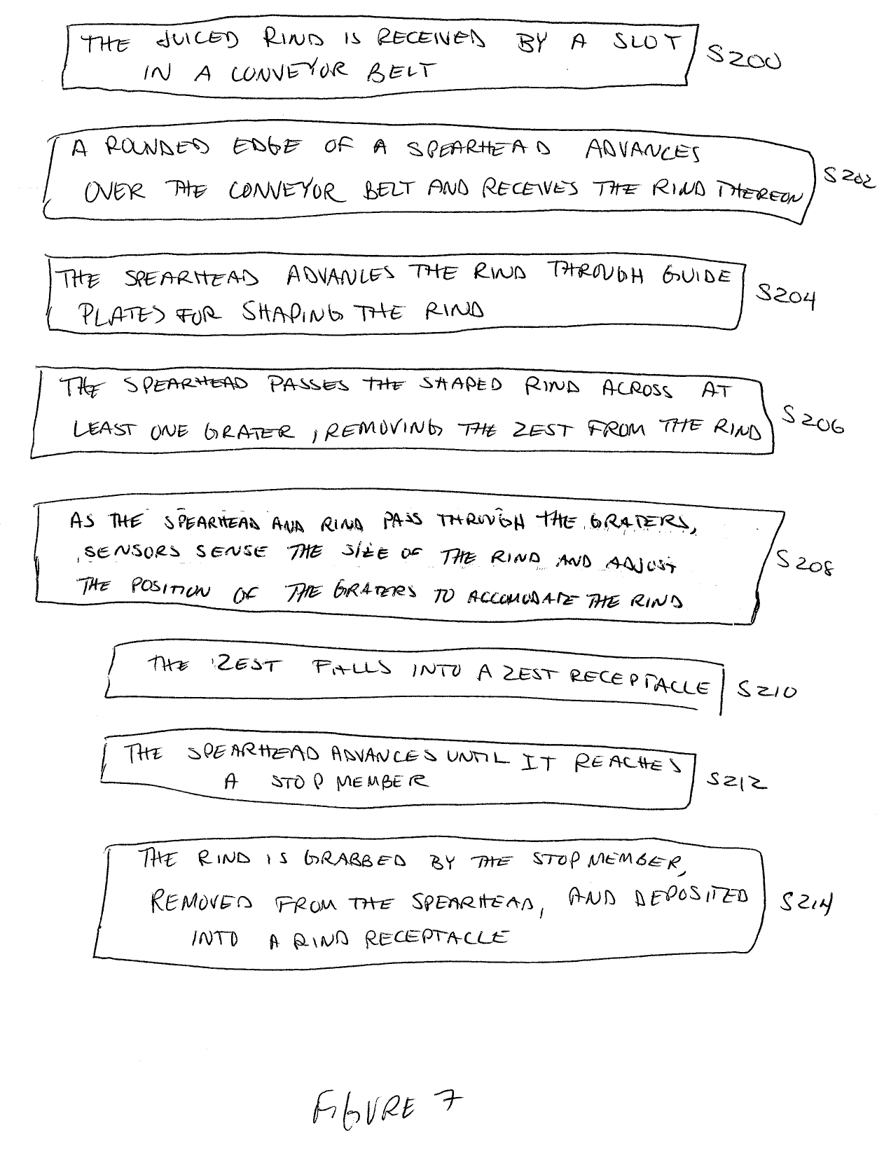

FIG. 7 is a flow diagram describing the method of zesting according to invention principles wherein the graters are movable to accommodate different size rinds and more efficiently remove the zest from a rind. In step S200 the juiced rind 16 is received by a slot 14 on the conveyor belt 12. If the juiced rind is completely flattened, the rind may need to be squeezed to provide a small opening for aiding in the receipt of the spearhead therein. In step S202 a rounded edge of the spearhead 18 advances over the conveyor belt 12 and receives the rind 16 thereon. Then in step S204, the spearhead 18 advances the rind through guide plates for shaping the rind to the desired dimensions for removing the zest therefrom. As described in step S206, the spearhead 18 passes the shaped rind across at least one grater 20 thereby removing the zest 36 from the rind 16. In step S208, as the spearhead and rind pass through the graters, sensors sense the size of the rind 16 and adjust the position of the grater(s) to accommodate the rind 16. Then in step S210, the removed zest 36 falls into a zest receptacle 32. In step S212, the spearhead 18 advances until it reaches a stop member 24. In step S214, the rind 16 is grabbed by the stop member, removed from the spearhead 18 and deposited into a rind receptacle 34.

FIG. 8 is a perspective view showing removal of a zested rind from the zesting system 10 according to invention principles. After the zest 36 has been removed from the rind 16 by the graters 20, the spearhead 18 advances until it reaches the stop member 24. A comb 40 then comes down and places itself over the spearhead 18. As the spearhead 18 returns to the start position, the comb 40 separates the zested rind 38 from the spearhead 18 and drops the zested rind in a rind receptacle for use in the production of other products. The above discussed method and apparatus for removing the rind from the spearhead after zesting is provided for purposes of example only, and other means may be used to remove the zested rind 38 from the spearhead 18. Once the zested rind 28 is removed from the spearhead and deposited in a rind receptacle 34, the spearhead 18 returns to the start position in order to grab another rind for zesting.

It will be understood that each of the elements described above, or two or more together may also find a useful application in other types of devices differing from the type described above.

While certain novel features have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A system for removing zest from a rind comprising:
a mobile member for receiving the rind thereon, said mobile member being movable in a lateral direction between a start position and an end position;
at least one grater positioned along the path of the mobile member, said grater removing the zest from the rind as said mobile member moves between said start and said end positions;
a first receptacle for receiving zest removed by said grater; and
a stop member positioned at said end position for removing the zested rind from said mobile member.

2. The system as recited in claim 1 further including a conveyor for receiving the rind and positioning the rind along the path of said mobile member where said mobile member is able to receive the rind when moving between the start and end positions.

3. The system as recited in claim 2 further including a pair of guide plates for shaping the rind received by the mobile member.

4. The system as recited in claim 3 wherein said guide plates are positioned on said conveyor.

5. The system as recited in claim 3 wherein said guide plates are positioned between said at least one grater and said conveyor.

6. The system as recited in claim 2 wherein said conveyor includes a plurality of sections, each of said plurality of sections selectively a respective rind.

7. The system as recited in claim 6 wherein a pair of guide plates are positioned within each of said plurality of sections, each guide plate being able to shape the respective rind after receipt by said mobile member.

8. The system as recited in claim 1 wherein said at least one grater is shaped to a contour of said mobile member.

9. The system as recited in claim 8 wherein said at least one grater includes a pair of graters, each of said pair of graters including a grating portion positioned to face one another.

10. The system as recited in claim 9 wherein said pair of graters are spring loaded thereby allowing for removing zest from varying sized rinds.

11. The system as recited in claim 8 wherein said at least one grater has a grating surface rotating in a direction opposite a direction of movement of said mobile member.

12. The system as recited in claim 8 wherein said at least one grater is semi-circular in shape.

13. The system as recited in claim 8 wherein said at least one grater includes a plurality of semi-circular shaped graters positioned to form a tube.

14. The system as recited in claim 13 wherein said tube is stationary and said moveable member passes the rind through the tube.

15. The system as recited in claim 1 wherein said mobile member has a rounded end for preventing said mobile member from piercing the rind when received.

16. The system as recited in claim 1 further including a second receptacle for receiving the rind after the zest has been removed therefrom.

17. A method for removing zest from a rind comprising the activities of:
a. Receiving the rind on a mobile member;
b. Moving the moveable member and rind in a lateral direction between a start position and an end position;
c. Passing the rind against a grating surface of at least one grater thereby removing the zest therefrom;
d. Receiving the removed zest in a first receptacle; and
e. Removing the zested rind from the mobile member at the end position.

18. The method as recited in claim 18 further comprising the activity of passing the rind through a pair of guide plates to shape the rind to a shape of the mobile member on which the rind is received.

19. The method as recited in claim 18 further comprising the activity of positioning the rind on a conveyor belt along the path of the mobile member, the mobile member receiving the rind as it passes from the start position to the end position.

20. The system as recited in claim 1 further including means for opening the find to facilitate receipt of the rind by the moveable member.

21. The system as recited in claim 2 wherein said conveyor moves in a direction perpendicular to the direction of said mobile member or rotates about an axis for positioning a rind in a path of the mobile member
